(19) United States
(12) Patent Application Publication
(10) Pub. No.: US 2013/0091032 A1
(43) Pub. Date: Apr. 11, 2013

(54) METHOD AND SYSTEM FOR CROSS SELLING OF GOODS AND SERVICES AMONG NON-AFFILIATED RETAIL MERCHANTS

(71) Applicants: Jane Prokop, Jersey City, NJ (US); Yakov Bindler, Jersey City, NJ (US)

(72) Inventors: Jane Prokop, Jersey City, NJ (US); Yakov Bindler, Jersey City, NJ (US)

(21) Appl. No.: 13/644,289

(22) Filed: Oct. 4, 2012

Related U.S. Application Data
(60) Provisional application No. 61/543,563, filed on Oct. 5, 2011.

(51) Int. Cl. G06Q 30/06

(52) U.S. Cl. 705/26.2

(57) ABSTRACT

Methods and systems are provided that encourage and provide informational and transactional support and infrastructure for cross-selling of products and services among otherwise unaffiliated merchants by formation of networks (e.g., social networks) of local merchants with knowledge of each others' products and services.

### CROSS-REFERENCE TO RELATED APPLICATIONS

This application claims the benefit, under 35 U.S.C. §119(e), of U.S. Provisional Patent Application Ser. No. 61/543,563, filed Oct. 5, 2011, the contents of which is hereby incorporated by reference in its entirety.

### FIELD OF THE INVENTION

The present invention relates to a method and a system for encouraging and providing informational and transactional support and infrastructure for cross-selling of products and services among otherwise unaffiliated merchants.

### BACKGROUND OF THE INVENTION

Increasing sales is one of the main objectives of a business establishment. Achieving this goal without additional investments into the business' infrastructure or inventory, while maintaining profit margins, would be an even more attractive proposition.

There are a number of methods and systems designed to bring customers to a business: print and outdoor advertisement, marketing and promotional campaigns, discount and manufacturers' coupons and, more recently, the popular daily deals that are distributed via email or mobile phone directly to consumers. The shortcomings of conventional approaches, especially for small businesses, are also well known: low credibility and hence low effectiveness of paid celebrity endorsers, poorly designed and executed local advertising campaigns, hassle with manufacturers' coupons and lower—or even negative—profit margins during giveaways that sometimes are poorly timed and/or supported.

The most widespread marketing and promotional efforts for a typical small business such as a restaurant, package store, auto repair shop or nail salon are believed to consist of print advertisement in a local penny saver and a chalk blackboard near the entrance door. Many do not even have websites, or have simple or poorly designed websites that fail to attract visitors. Meanwhile, a consumer seeking a product or service is usually limited to just a few options such as (a) conducting her own research using sources such as local newspapers, (b) risking poor service by doing no research at all, or (c) using recommendations from people of unknown qualifications such as reviewers on message boards and review-aggregating websites. Information that is perceived to be reliable, from a local source known to and trusted by the consumer, is very rarely available.

In addition, even in the case of a diligent and educated consumer, not all of the information is readily available to people “on the go” who do not have an expensive smart phone or/and a credit card to “lock in” an attractive deal.

Accordingly, there is believed to be a need for systems and methods that increase sales for participating businesses and provide consumers with convenience, value, reliable information, and an increased selection of products and services.

### SUMMARY OF THE INVENTION

In accordance with example embodiments of the present invention, a method and a system are provided that encourage and provide informational and transactional support and infrastructure for cross-selling of products and services among otherwise unaffiliated merchants by formation of networks (e.g., social networks) of local merchants with knowledge of each others' products and services.

In accordance with example embodiments of the present invention, the systems create a network (e.g., social network) of merchants operating retail establishments in a geographic locality such as a village, community, and/or any other area which may be, for example, defined by being walkable or drivable within a period of time that is reasonable in the context of potential economic benefit derived from receiving a discount on products or services sold/provided by the merchants. The merchants' physical locations may be equipped with informational interfaces such as, for example, audio and/or display devices (e.g., flat screen TVs/displays/monitors and/or any other suitable display(s)) configured to provide information on selected deals, discounts, and promotions for goods and services sold and provided by the members of the network. A proprietor/merchant may operate one or more separate communication devices such as, for example, a tablet computer, PC, and/or mobile phone that would have access to a full list of the deals, discounts and promotions for goods and services sold and provided by the members of the network. In accordance with some example embodiments of the present invention, the deals and discounts would not be available to a potential customer outside of the network (for example, the deals and discounts may not be available to the customer if the customer simply visits the selling merchant's physical retail location).

In accordance with example embodiments of the present invention, a customer of a retail establishment would be able (for example, with the possible assistance and guidance of the proprietor) to select a deal, product, and/or service offered by one or more members of the network, purchase it and receive proof of such purchase. The customer later could go to pick up the merchandise or receive the purchased service from the selling merchant/service provider, have the merchandise delivered to her home or other location, or opt for a later pick up of the merchandise at the location where she made the purchase.

In accordance with example embodiments of the present invention, the customer payment is processed by the system's payment processing system (e.g., according to a payment processing algorithm) which could include ACH payment distribution among selling merchants/service providers and/or facilitating merchants.

In accordance with example embodiments of the present invention, each system participant receives its pre-negotiated portion of the payment.

In accordance with example embodiments of the present invention, the system, in effect, transforms unrelated stores into a virtual department store, allowing each member of the network to sell its products and services through a number of sales agents while simultaneously providing the member with access to the inventory of other network members.

A method in accordance with example embodiments of the present invention includes: providing a network between a plurality of merchants; directing offers from an offering merchant to a point-of-sale merchant, the offer being directed to the purchase by a consumer of a product sold by the offering merchant; and directing order data from the point-of-sale merchant to the offering merchant, the order data being obtained from a consumer at a physical location of the point-of-sale merchant, at least one of (a) the providing the network, (b) the directing offers, and (c) the directing order data being performed using a computer processor.

The method may also include directing payment from the consumer to the point-of-sale merchant and the offering merchant.

Further features and aspects of example embodiments and/or methods of the present invention are described in more detail below with reference to the appended Figures. Additional specific embodiments, aspects and advantages of the present invention are not restricted by the exemplary embodiments of the present invention.

### BRIEF DESCRIPTION OF THE DRAWINGS

FIG. 1 shows data flow in accordance with an example system and method of the present invention.

FIG. 2 shows payment flow in accordance with an example system and method of the present invention.

FIG. 3 shows an alternative payment flow in accordance with an example embodiment of the present invention.

FIG. 4 shows a chart describing point-of-sale merchant interaction with a merchant network.

FIG. 5 shows a chart describing an offering merchant interaction with a merchant network.

FIG. 6 shows basic functionality of the merchant network.

### DETAILED DESCRIPTION

As to the figures, like reference characters indicate corresponding or like elements throughout the several figures.

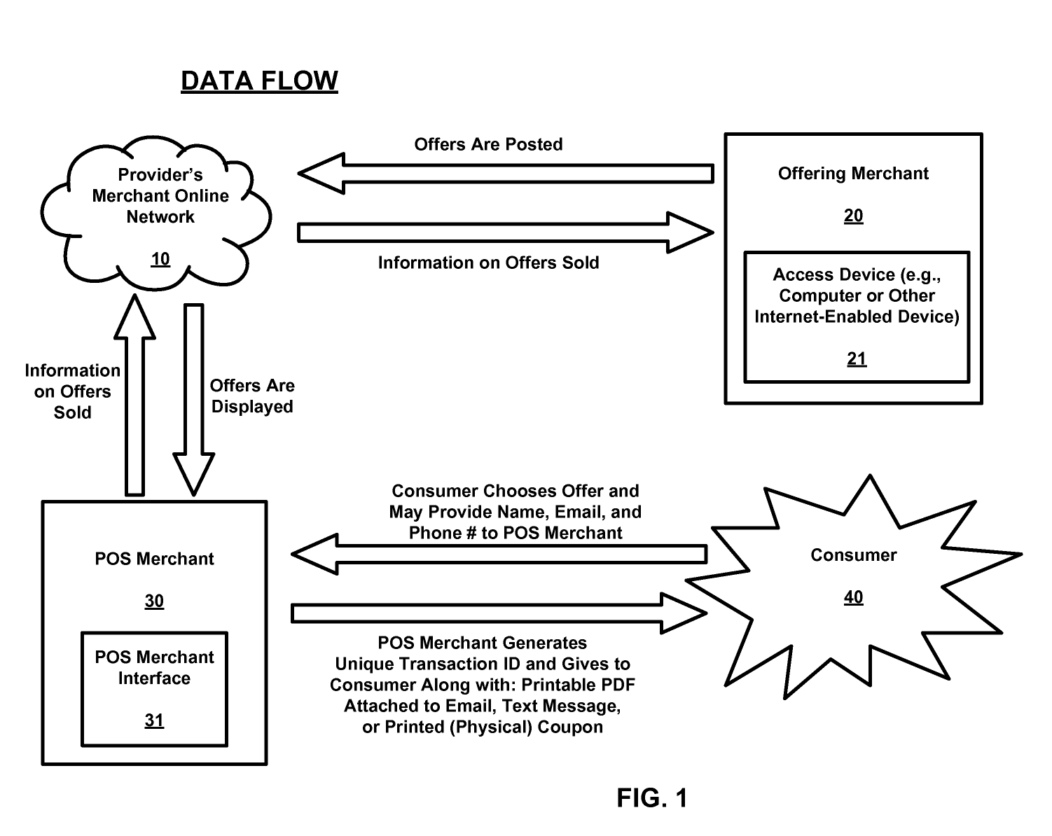

FIG. 1 schematically shows data flow in accordance with an example system and method of the present invention. In general, the system is set up and provided by a provider (e.g., a business entity that coordinates the system and provides resources such as, e.g., software and hardware in connection with the system).

Via the provider's merchant online network 10, an offering merchant 20 posts or otherwise provides offers that are transmitted to a point-of-sale (“POS”) interface 31 of a POS merchant 30. The POS interface may include, e.g., a display, an input device such as a keyboard, touch screen, and/or a microphone, among others. The offering merchant 20 transmits the offers via an access device 21, which may include, for example, a computer or other internet-connected device.

When a consumer 40 physically visits the POS merchant, the consumer 40 is presented with the offers displayed by the POS merchant interface 31, which may be, for example, part of a dedicated kiosk or other suitable arrangement. If the consumer 40 decides to pursue one or more of the offers, the consumer chooses the offer via a purchase instruction input into the POS merchant interface 31. The consumer 40 may then be requested or required by the POS merchant interface 31 (e.g., in response to the purchase instruction) to enter the name, email address, phone number, mailing address, and/or any other information needed to facilitate the transaction. This information may correspond to the consumer 40 and/or to an individual for whom the consumer 40 intends to retrieve or otherwise obtain the purchased goods or services. Once the purchase is completed, the consumer 40 is provided (e.g., by the POS merchant 30 and/or via POS merchant interface 31) with a unique tracking ID (e.g., a tracking number) corresponding to the purchase. In addition, the consumer 40 may be provided with a printable document (e.g., an image such as a PDF image) attached to an email, a text message, and/or a physical (e.g., printed) coupon.

Upon completion of the purchase, the corresponding purchase information is transmitted to the network 10, which conveys the purchase data back to the offering merchant 20 (e.g., via access device 21).

After receiving the purchase information, the offering merchant 20 processes the purchase order to make available the purchased goods and/or services to the consumer 40. Once the goods and/or services are available, the offering merchant may generate a communication (e.g., an email, text message, and/or a phone message, among others). Purchased goods may be picked up by the consumer 40 directly from the offering merchant 20 or they may be shipped to the consumer 40 (for example, in accordance with the user's shipping information entered via the POS merchant interface 31 at the time of purchase). Further, the consumer 40 may be queried (for example, at the time of purchase at the POS merchant interface 31) for a selection of retrieval of goods and/or services (for example, a choice to pick-up or have delivered the goods).

For conciseness, the illustrated embodiments only show a one-way transaction among two merchants 20, 30. However, it should be appreciated that any given offering merchant may also be a POS merchant for one or more other offering merchants (for example, POS merchant 30). Accordingly, an extended network may be provided, whereby merchants are able to advertise and sell their services in a greater number of retail locations. This may be especially advantageous for merchants that are small in size (e.g., a single or only a few physical locations), and/or have limited resources.

Although the illustrated example includes the consumer 40 physically visiting the POS merchant 30, it should be understood that a similar system may be provided via a website of the POS merchant 30. For example, a window, link, and/or other display may be provided via the website to present the offer information of the unaffiliated merchants (e.g., offering merchant 20).

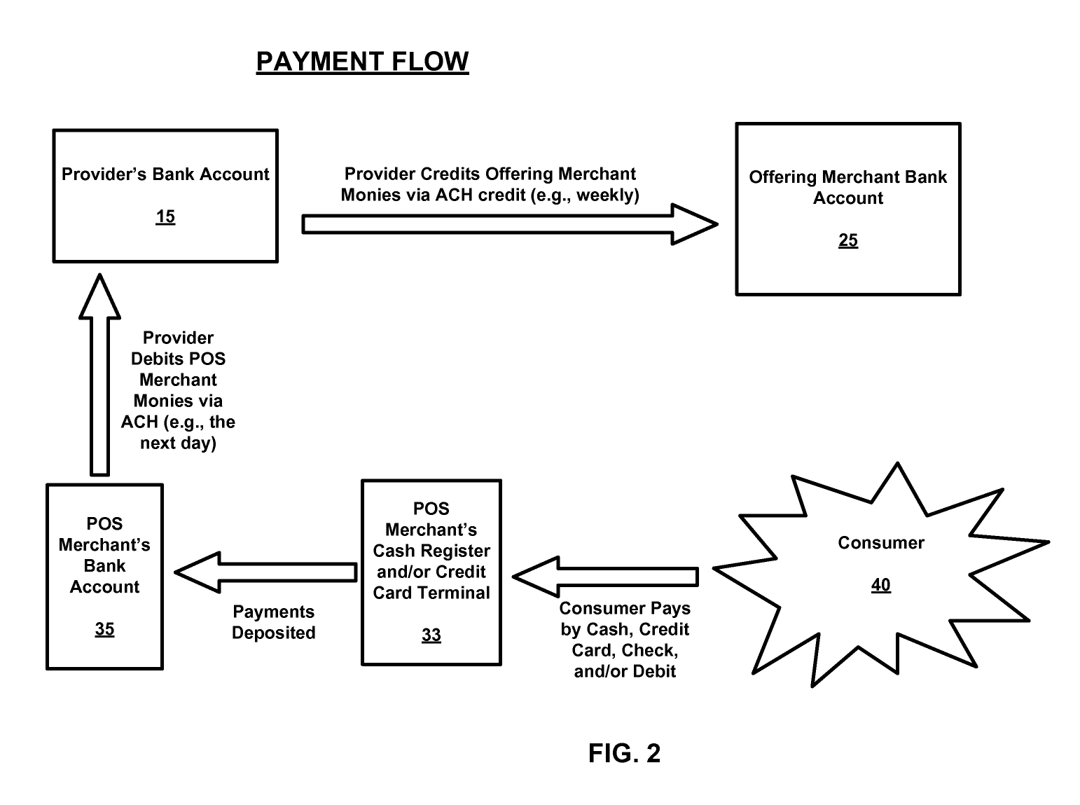

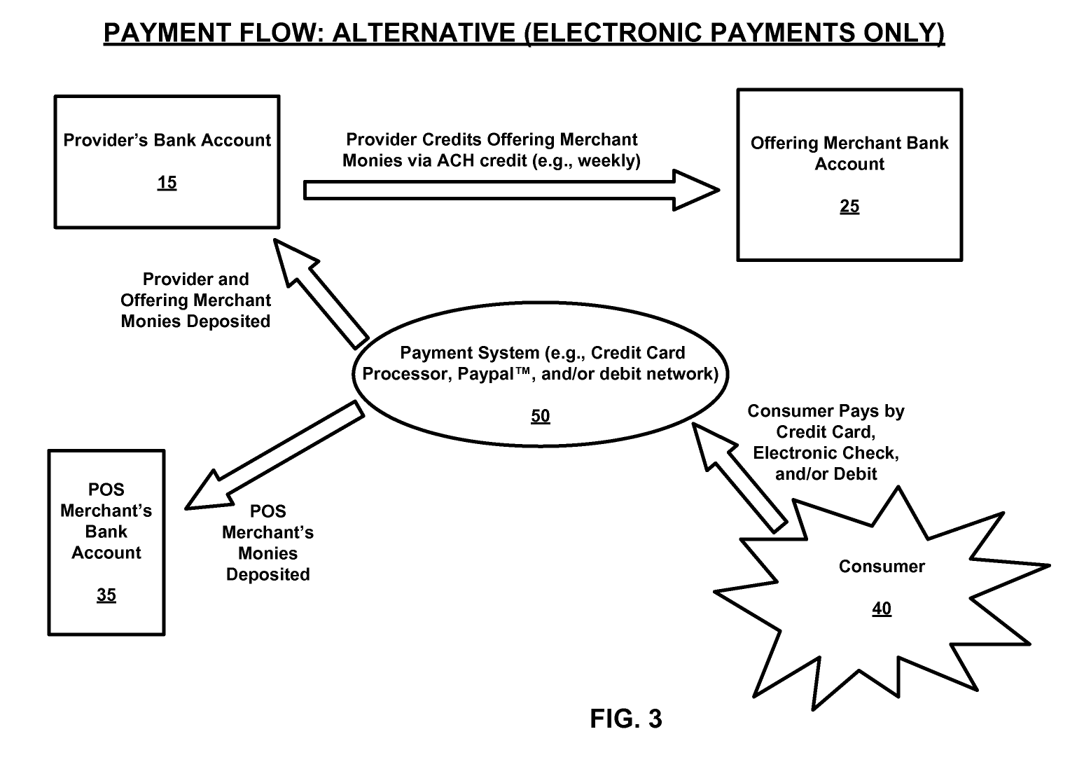

In connection with the system of FIG. 1, FIGS. 2 and 3 show two different payment flow arrangements. Referring to FIG. 2, the consumer pays (e.g., at the time of purchase) by cash, credit card, check, and/or debit. This payment is processed by the POS merchant's cash register and/or credit card terminal 33 and deposited into the POS merchant's bank account 35. The provider then debits from the POS merchant's bank account 35 any required money via an automated clearing house (“ACH”) process, e.g., the next day. The provider then credits the offering merchant's bank account 25 the amount of money to cover the purchase (e.g., via an ACH credit). The split of funds between the Offering Merchant, the provider of the system, and the POS Merchant is agreed in advance.

Referring the alternative arrangement of FIG. 3, which is only for electronic payments, the consumer 40 pays electronically, e.g., by credit card, electronic check, or debit. The payment is made through a payment system 50, such as, e.g., a credit card processor, an online payment processing service such as PayPal™, and/or a debit network). The payment system 50 then deposits the POS merchant's payment into the POS merchant's bank account 35 and the provider and offering merchant's payments into the provider's bank account 15. The provider in turn from time to time credits (e.g., via ACH credit) the offering merchant's payment into the offering merchant's bank account 25. The arrangement of FIG. 3 may require agreements to be negotiated with the payment processors associated with the payment system 50. These agreements may be between the payment processor and the provider and/or the merchants.

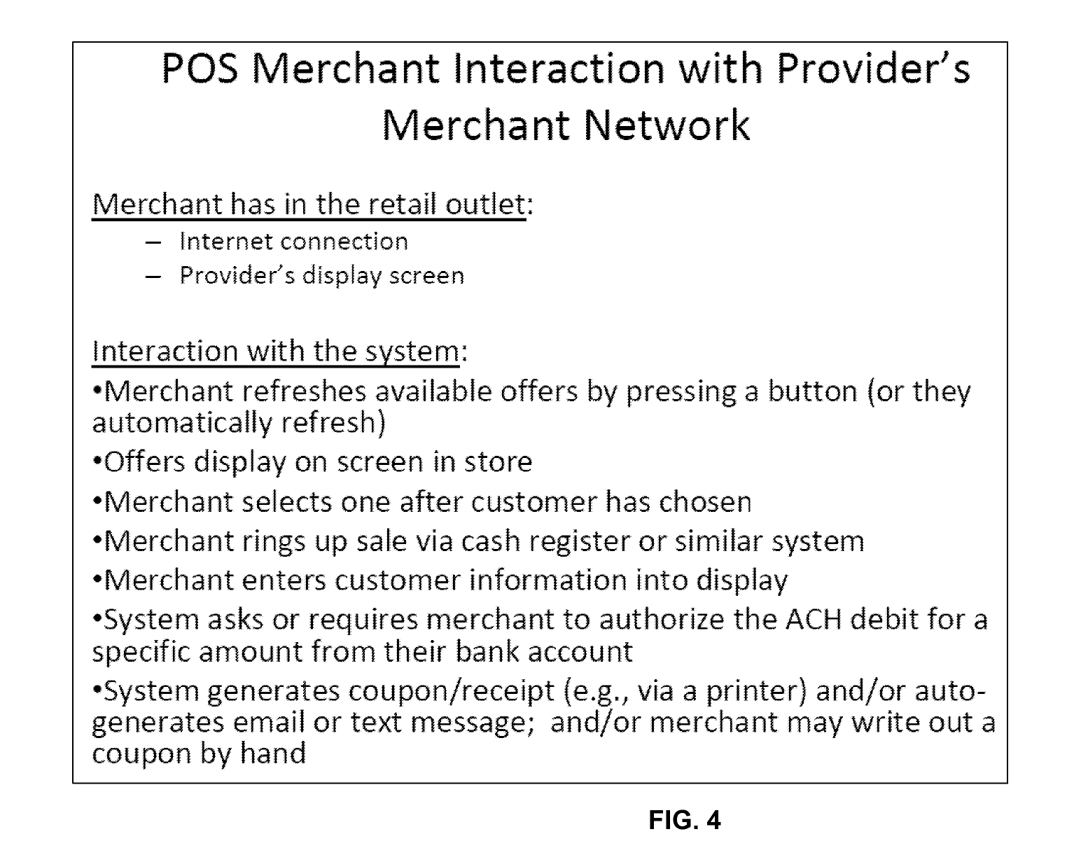

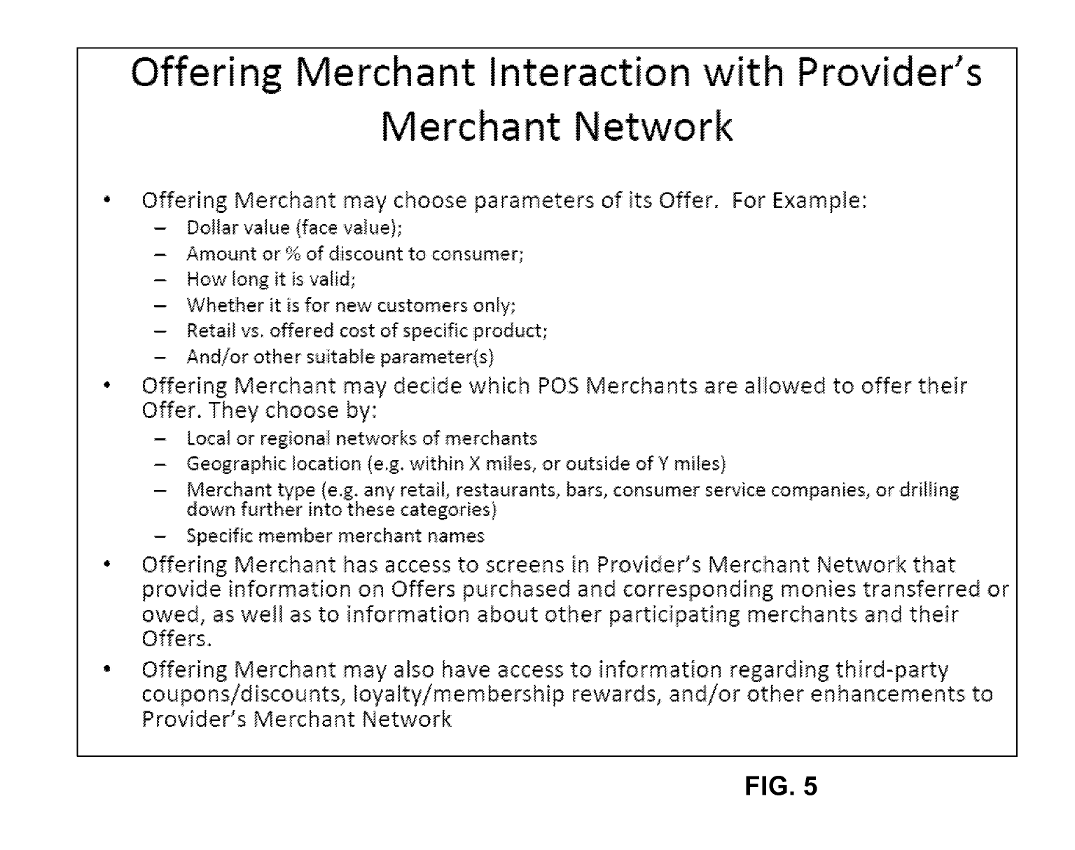

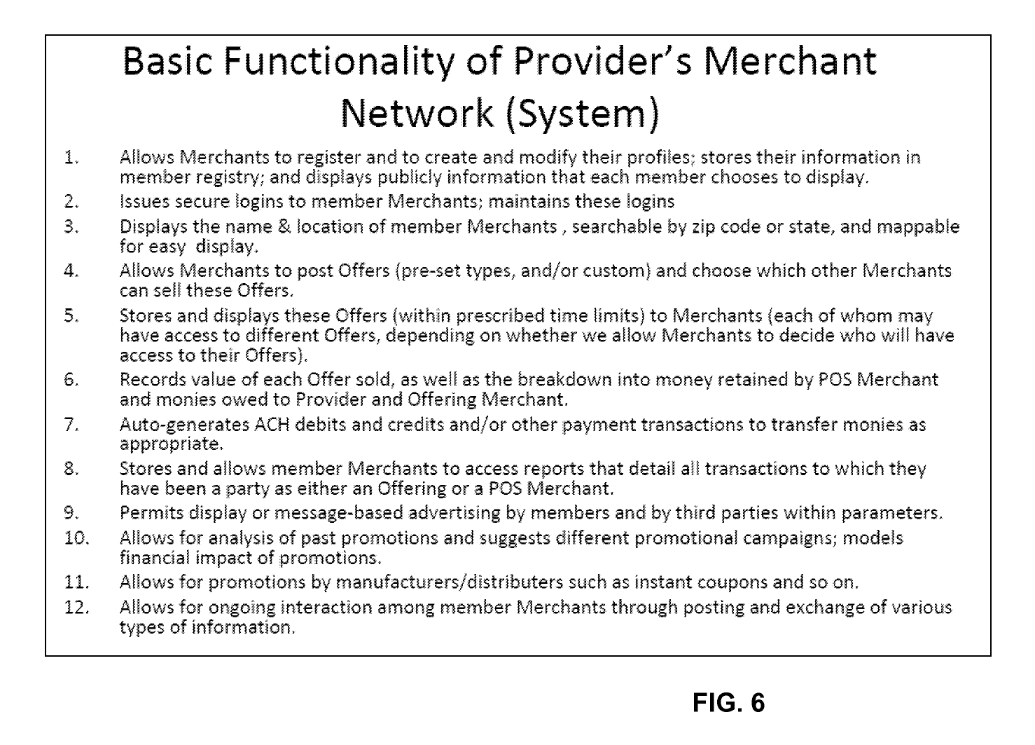

Additional features of the system are provided in FIGS. 4 to 6, in which FIG. 4 shows a chart describing point-of-sale merchant interaction with a merchant network, FIG. 5 shows a chart describing an offering merchant interaction with a merchant network, and FIG. 6 shows basic functionality of the merchant network.

The network and method may have features in addition, or as an alternative, to the features described above. For example, Offering Merchants and POS Merchants may offer joint promotions of their products and services. An example of such a joint promotion might be as follows: The purchase of a given product(s) normally found in the retail location of the POS Merchant could entitle the purchaser to a discount on a product normally found in the retail location of another merchant in the network.

Further, third-party coupons may be provided for use by consumers 40 at the site of the POS merchant 30, for products that are sold by the POS merchant 30 and/or for products (e.g., goods and/or services) of the offering merchant 20.

Further, suggestions and/or guidance may be proactively offered to participating merchants about which offers to put out to the network. The suggestions may be driven by data that the provider would have in the system (e.g., in one or more databases accessible by a computer system) with respect to, e.g., industry trends, product pricing changes, consumer purchasing trends, and/or economic trends, among others. A proprietary algorithm may determine the suggestions to each participating merchant. The algorithm may be executed by a computer processor executing a set of instructions stored on a computer memory (e.g., RAM, ROM, etc.).

The provider may proactively suggest which other participating merchants a particular merchant should partner with. These suggestions may be based, for example, on internal data and algorithms—for example, regarding complementary relationships among different product offerings, suitable distance geographically, as well as industry trends, product pricing changes, consumer purchasing trends, and/or economic trends, among others. A proprietary algorithm may determine the partnering suggestions to each participating merchant. The algorithm may be executed by a computer processor executing a set of instructions stored on a computer memory (e.g., RAM, ROM, etc.).

Moreover, loyalty programs and/or membership point programs may be provided from merchants and/or third parties to consumers 40, and/or from third parties to merchants. For example, manufacturers/distributors could offer rewards to merchants who increase their sales of a given product through offering on-site coupons via the provider's system. As another example, manufacturers/distributors could offer rewards to consumers who make multiple purchases of their product through offers on the provider's system. As yet another example, merchants could offer their own rewards to consumers who purchase offers related to their products/services.

According to example embodiments of the present invention, a device transmits a code or data indicating the obtainment of the code, which transmitted code or data indicates the presence of a consumer at a location of a first merchant to a device associated with a second merchant, and according to the obtained code or data, a commission is provided to the first merchant for a sale conducted at the second merchant in which an item is sold to the consumer.

For example, in an example embodiment, a first processing device receives input of a code. Responsive to the input, the first processing device transmits to a second processing device an identification of the code in a communication associated with a first merchant. Based on receipt by the second processing device of the identification of the code, a commission is then credited to an account associated with the first entity when the code is again input at the second processing device when a sale is recorded at the second processing device for a second merchant.

For example, the first processing device, in an example embodiment, is located at a store of the first merchant and is associated with the first merchant. The consumer enters the store and places a card in proximity to the first processing device. a sensor of the first processing device senses a code of the card. The consumer then takes the card to the store of the second merchant and places the card in proximity of the second processing device located at the store of the second merchant, e.g., at time of checkout. The second device, based on a communication from the first processing device noting the code, matches the code of the communication from the first processing device to the sensed code, and accordingly applies a commission to the first merchant for the sale conducted at the store of the second merchant.

A non-exhaustive list of example sensors includes a proximity sensor, a radio frequency identification (RFID) sensor, and an optical reader. The code is of any suitably appropriate type, suitable for being sensed by the sensor being used. The code can be, for example, a barcode a Quick Response (QR) code, or a unique frequency.

According to an alternative example embodiment, a consumer carries a device that senses a code provided at a location of a first merchant, where the code identifies the first merchant. The consumer then takes the device to a location of a second merchant and brings the device in proximity of a device of the second merchant for sensing of the code, and processing of the commission to the first merchant for a sale conducted by the second merchant to the consumer. For example, the consumer's device can take an image of a code displayed at the store of the first merchant, and display the recorded image. The device of the second merchant can then take an image of the display, and process the code to identify the first merchant. Alternatively, other types of sensors and codes can be used, as described above.

Similarly, according to an example embodiment, a customer obtains a card from a first merchant. The card is updated to include a code that identifies the first merchant. Subsequently, the customer provides the card to the second merchant, who scans the card into a reading/processing device. The reading/processing device then processes the code for allocating a commission to the first merchant with which the code is associated.

According to example embodiments of the present invention, hen the device of the second merchant records the code, a discount is applied to the sale, thereby providing the customer an incentive to provide the code.

According to an example embodiment, a customer carries a reading device, e.g., an image sensor, proximity-based sensor, frequency sensor, etc. When the customer carries the sensor near or to a device of a first merchant, the reader reads a code identifying the first merchant, and transmits data indicating the reading event and identifying the first merchant to a central processing device, e.g., via a network, such as the Internet. Similarly, when the customer carries the sensor near or to a device of a second merchant, the reader reads a code identifying the second merchant, and transmits data indicating the reading event and identifying the second merchant to the central processing device. Based on the timing of the received codes, e.g., times of the receipt by the central device, which times are recorded by the central device or timestamps provided with the codes, the central device (or another processing device) determines whether a commission should be paid to the first merchant for a sale recorded at the second merchant. For example, if the codes and times indicate that the customer completed a purchase transaction with the second merchant shortly (defined according to a preprogrammed maximum time threshold) after the customer was at the location of the first merchant, the transaction is partially credited to the first merchant (since it can be assumed, according to these conditions, that the first merchant encouraged the customer to go to the second merchant for the item). Discounts can similarly be applied to encourage the consumer to carry the card.

It is noted that aside from timing, there can be other considered conditions, according to example embodiments of the present invention. For example, certain items of the first merchant can be associated with certain items of the second merchant, so that a discount or commission is applied for a transaction for a first specified item conducted with one merchant conditional upon a transaction for a second specified item conducted with another merchant. For example, the scanned/sensed codes can further identify the purchased items. For example, if a consumer purchases an item of clothing from one merchant, then the discount and commission for the sale from a second merchant can be limited to only the portion of the sale associated with other items of clothing. Similarly, the purchase of an item of clothing from one merchant can be bundled with the purchase of a tailoring service at another merchant. The merchants can agree on which items and/or services are to be bundled, and the programs of the coordinating systems can be updated accordingly.

Any of the actions described herein may be performed using one or more computer systems. The various computer-based systems described herein may each include a storage component for storing machine-readable instructions for performing the various steps processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Accordingly, example embodiments of the present invention are directed to a computer processing device programmed to perform one or more methods described herein, e.g., based on sensor data. Example embodiments of the present invention are directed to one or more methods described herein, performed by one or more computer processing devices and/or sensors. Example embodiments of the present invention are directed to a hardware, non-transitive, computer-readable medium on which are stored instructions executable by a processor, which instructions, when executed by the processor, cause the processor, to perform one or more of the methods described herein. Example embodiments of the present invention are directed to a method of transmitting instructions, which instructions are executable by a processor to cause the processor to perform one or more of the methods described herein.

The above description is intended to be illustrative, and not restrictive. Those skilled in the art can appreciate from the foregoing description that the present invention may be implemented in a variety of forms, and that the various embodiments may be implemented alone or in combination in various combinations. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A computer-implemented merchant network method, comprising:
providing, by a processing device of a first entity, data for recording a purchase of at least one of an item of an inventory database of a second entity and a service of the second entity; and
based on the recording, allocating, by the processing device of the first entity or another processing device, a first portion of a payment for the sold at least one of item and service to the first entity and a second portion of the payment to the second entity.

2. The method of claim 1, further comprising:
obtaining, by the processing device, identifying indicia that identifies the purchase and that is recorded in a system of the second entity in a record of the purchase of the at least one of item and service.

3. The method of claim 1, further comprising:
debiting, by a processing device and from an account associated with the first entity, at least the first portion of the payment; and
crediting, by the processing device and to an account associated with the second entity, the first portion of the payment.

4. The method of claim 3, further comprising:
receiving by a processing device of a third entity information regarding the at least one of item and service of the second entity; and
providing by the processing device of the third entity and to the processing device of the first entity information indicating an availability of the at least one of item and service of the second entity for sale by the first entity.

5. The method of claim 4, further comprising:
automatically debiting from the account associated with the first entity a second portion of the payment; and
automatically crediting an account associated with the third entity the second portion of the payment.

6. A computer-implemented merchant network method, comprising:
recording by a first processing device of a first entity a list of members; and
for each of a plurality of the members:
receiving, by the first processing device and from a second processing device of the respective member, an identification of a least one of an inventory item and a service of the respective member that is available for sales processing by one or more of the other members, the respective member thereby being an offering member;
transmitting, by the first processing device and to a respective third processing device of each of the one or more of the other members, a notification of the availability of the at least one of item and service for sales processing;
receiving, by the first processing device and from one of the third processing devices of a respective one of the one or more of the other members, a notification of sales processing of the at least one of item and service; and
allocating, by the first processing device, respective portions of revenue from the sales processing of the at least one of item and service to the respective offering member and to the respective one of the one or more of the other members.

7. The method of claim 6, further comprising:
transmitting, by the first processing device and to the second processing device, the notification of the sales processing of the at least one of item and service.

8. The method of claim 6, further comprising:
based on profile information of the offering member and profile information of others of the list of members, automatically matching, by the first processing device, a subset of the others of the list of members to the offering member; and
based on the matching, transmitting by the first processing device and to the second processing device, an identification of the members of the subset as recommended merchants at which to make available for sales processing one or more of at least one of inventory items and services of the offering member.

9. A computer-implemented merchant network method, comprising:
receiving, by a first processing device of a first entity, an identification of at least one of an item and a service of a second entity that is available for sales processing by the first entity;
transmitting, by the first processing device for receipt by a second processing device of the second entity, a notification of a sales processing of the at least one of item and service; and
allocating, by the first processing device or another processing device, a first portion of a payment for the sales processing to the first entity and a second portion of the payment to the second entity.

10. A computer-implemented merchant network method, comprising:
transmitting, by a first processing device of a first entity, a notification of an availability of at least one of an item and a service of the first entity for sales processing by a second entity;
receiving, by the first processing device, a notification of a sale of the at least one of item and service by the second entity;
responsive to the receiving of the notification of the sale, recording the sale by the first processing device; and
recording, by the first processing device, an accounts receivable for a first portion of a sales price for the sales processing, a second portion of the sales price being allocated to the second entity.

11. A computer-implemented merchant network method, comprising:
receiving input, by a first processing device, of a code; and
responsive to the input, transmitting, by the first processing device and to a second processing device, an identification of the code in a communication associated with a first entity;
wherein, based on receipt by the second processing device of the identification of the code, a commission is credited to an account associated with the first entity responsive to subsequent input of the code at the second processing device.

12. The method of claim 11, wherein:
the first processing device includes a sensor;
for the receipt of the input of the code by the first processing device, the sensor of the first processing device senses a signal representative of the code, the representation being provided by an object;
the second processing device includes a sensor; and
for the input of the code at the second processing device, the sensor of the second processing device senses the signal representative of the code provided by the object.

13. The method of claim 12, wherein the sensors include an optical reader.

14. The method of claim 12, wherein the sensors include a proximity sensor.

15. The method of claim 12, wherein the sensors include a radio frequency identification sensor that senses a frequency emitted by the object.

16. A computer-implemented merchant network method, comprising:
receiving, by a first processing device and from a second processing device, an identification of a code;
subsequently receiving input of the code at the first processing device;
responsive to the receipt of the input of the code:
applying, by the first processing device, a discount to a sale; and
allocating, by the first processing device, to an entity associated with the second processing device, and based on the receipt of the identification of the code from the second processing device, a portion of a payment for the sale.

17. The method of claim 16, wherein the identification of the code is received by the first processing device from the second processing device in response to a sensing of the code by a sensor of the second processing device, and the input of the code at the first processing device is performed by a sensor of the first processing device sensing the code.

18. The method of claim 17, wherein the sensing of the code by the sensors of the first and second processing devices is by sensing a representation of the code in an object.

19. The method of claim 18, wherein the representation is one of a barcode and a Quick Response (QR) code.

20. A computer-implemented merchant network method, comprising:
receiving at a first processing device input of a code that identifies a first entity; and
responsive to receipt of the input of the code:
applying, by the first processing device, a discount to a sale of at least one of an item and a service of a second entity; and
allocating, by the first processing device, a portion of a payment for the sale to the first entity.

21. The method of claim 20, wherein a representation of the code is applied to an object by a second processing device of the first entity, and the receipt of the input of the code is by sensing of the representation applied to the object.

22. A computer-implemented method merchant network method, comprising:
receiving, by a first processing device, first data from a second processing device indicating presence of the second processing device at a first location associated with a first merchant;
receiving, by the first processing device, second data from the second processing device indicating presence of the second processing device at a second location associated with a second merchant;
responsive to the first and second data, and based on a timing relationship between the presences indicated by the first and second data, causing, by the first processing device, allocation of a sales commission to the first merchant for a sale recorded as being made by the second merchant.

23. The method of claim 22, wherein the second processing device is coupled with a sensor that senses a first code associated with the first merchant, responsive to which the first data is transmitted by the second processing device to the first processing device, and that senses a second code associated with the second merchant, responsive to which the second data is transmitted by the second processing device to the first processing device.

24. The method of claim 23, wherein the sensor is a radio frequency identification (RFID) sensor.

25. The method of claim 23, wherein the sensor is a camera.
